(19) United States
(12) Patent Application Publication
(10) Pub. No.: US 2015/0116714 A1
(43) Pub. Date: Apr. 30, 2015

(54) AUTHENTICATING DEVICE

(71) Applicant: International Currency Technologies Corp., Taipei City (TW)

(72) Inventors: Yi-Jen PAN, Taipei City (TW); Terng-Chiong YOU, Taipei City (TW); Hung-Fu WAN, Taipei City (TW); Ling-Ta SU, Taipei City (TW); Tien-Yuan CHIEN, Taipei City (TW)

(73) Assignee: International Currency Technologies Corp., Taipei City (TW)

(21) Appl. No.: 14/065,356

(22) Filed: Oct. 28, 2013

(51) Int. Cl. G07D 7/12; G01J 3/10; G01J 3/50

(52) U.S. Cl. CPC G07D 7/122; G01J 3/50; G01J 3/10; G01J 2003/104
USPC 356/406; 356/402

(57) ABSTRACT

An authenticating device is used for optically authenticating a testing area of a first surface of a valuable document. The valuable document defines a normal perpendicular to the first surface and a datum penetrating the normal and two sides of the valuable document. The datum and the first surface collectively define a first area and a second area adjacent to the first area. The authenticating device includes a first light emitting unit, a second light emitting unit, and a light receiving component. The first light emitting unit is arranged within the first area. The second light emitting unit is arranged within the first area. The light receiving component is arranged within the second area. The first light emitting unit and the second light emitting unit emit light to the testing area in sequence for authenticating the variable document.

### BACKGROUND OF THE INVENTION

1. Field of the Invention

The present invention relates to an authenticating device, and in particular to an authenticating device for authenticating valuable document.

2. Description of Related Art

In present, technology advanced shortens the distance between people, and fastens the pace of people's lives, and makes people's demand tend to convenient and fast. By considering convenience and promptness, many public places provide automatic trading machines, such as vending machine or automated teller machine (ATM). The automatic machine not only saves staff wages, but also increases convenient which is willing accept by modern man.

Since counterfeit money is produced by many unscrupulous people and circulated in market, an authenticating device is disposed within the automatic machine to authenticate the paper money before receiving thereof.

The anti-counterfeiting technology applied on the paper money and visible by eyes includes watermark, security thread, hidden word, tiny word, gravure, and optical variable ink (OVI), and the most effective to against counterfeit is optical variable ink. Optical variable ink is one of an anti-counterfeit ink and has advantages of good anti-counterfeit, easily authentication and usage such that how to provide an authenticating device with optical variable ink authenticating technology to increase anti-counterfeit is a goal of the industry must effort.

### SUMMARY OF THE INVENTION

It is an object to provide an authenticating device.

Accordingly, the authenticating device according to one aspect of the present invention is used for optically authenticating a testing area of a valuable document, the testing area is located on a first surface of the valuable document, the valuable document defines a normal perpendicular to the first surface and a datum penetrating the normal and two sides of the valuable document, the datum and the first surface collectively define a first area and a second area adjacent to the first area. The authenticating device comprises a first light emitting unit, a second light emitting unit, a light receiving component, and a controller. The first light emitting unit is arranged within the first area, a first angle spans between an optical axis of the first light emitting unit and the normal. The second light emitting unit is arranged within the first area, a second angle spans between an optical axis of the second light emitting unit and the normal, the second angle is larger than the first angle. The light receiving component is arranged within the second area, and a third angle spans between an optical axis of the light receiving component and the normal. The controller is electrically connected to the first light emitting unit and the second light emitting unit, the controller is configured to control the first light emitting unit and the second light emitting unit emits light to the testing area in sequence.

In an embodiment of the present invention, the first angle is between 0 and 30 degrees, the second angle is between 40 and 80 degrees, and the third angle is between 0 and 20 degrees.

In an embodiment of the present invention, the first light emitting unit and the second light emitting unit generate white light, the light receiving component is color sensor.

In an embodiment of the present invention, the first light emitting unit and the second light emitting unit comprises a red light emitting component, a green light emitting component, and a blue light emitting component, respectively, the red light emitting component, the green light emitting component, and the blue light emitting component are electrically connected to the controller, the controller is configured to control the red light emitting component, the green light emitting component, and the blue light emitting component to emit light in sequence, and the light receiving component is a monochromatic light sensor.

In an embodiment of the present invention, the authenticating device further comprises a third light emitting unit, a forth light emitting unit, and a sub-light receiving component. The third light emitting unit, the forth light emitting unit, and the sub-light receiving component are arranged ahead a second surface opposite to the first surface of the valuable document, the second surface defining the normal and the datum penetrating the normal and the sides of the valuable document. The second surface and the datum collectively define a third area and a forth area adjacent to the third area. The third light emitting unit and the forth light emitting unit are arranged within the third area. The first angle spans between the third light emitting unit and the normal, and the second angle spans between the second light emitting unit and the normal. The sub-light receiving component is arranged within the forth area, and the third angle spans between the sub-light receiving component and the normal.

The authenticating device according to another aspect of the present invention is used for optically authenticating a testing area of a valuable document. The testing area is located on a first surface of the valuable document, the authenticating device arranged on the first surface with a predetermined height, the valuable document defining a normal perpendicular to the first surface. The authenticating device comprises a first light emitting unit, a second light emitting unit, a light receiving component, and a controller. A first angle spans between an optical axis of the first light emitting unit and the normal, a second angle spans between an optical axis of the second light emitting unit and the normal, and a third angle spans between an optical axis of light receiving component and the normal. The controller is electrically connected to the first light emitting unit and the second light emitting unit, the controller is configured to control the first light emitting unit and the second light emitting unit emits light to the testing area in sequence.

In an embodiment of the present invention, the first light emitting unit and the second light emitting unit generate white light, the light receiving component is color sensor.

In an embodiment of the present invention, the first light emitting unit and the second light emitting unit comprises a red light emitting component, a green light emitting component, and a blue light emitting component, respectively, the red light emitting component, the green light emitting component, and the blue light emitting component are electrically connected to the controller, the controller is configured to control the red light emitting component, the green light emitting component, and the blue light emitting component emits light to the testing area in sequence, and the light receiving component is a monochromatic light sensor.

In an embodiment of the present invention, the authenticating device further comprises a third light emitting unit, a forth light emitting unit, and a sub-light receiving component. The third light emitting unit, the forth light emitting unit and the sub-light receiving component are arranged on a second surface opposite to the first surface of the valuable document with a predetermined distance, the first angle spans between an optical axis of the third light emitting unit and the normal, the second angle spans between an optical axis of the forth light emitting unit and the normal, and the third angle spans between an optical axis of the sub-light receiving component and the normal.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a schematic view of an authenticating device according to a first embodiment of the present invention.

FIG. 2 is a perspective view of a valuable document.

FIG. 3 is an operational diagram of the authenticating device according to the first embodiment of the present invention.

FIG. 4 is another operational diagram of the authenticating device according to the first embodiment of the present invention.

FIG. 5 is a circuit block diagram of the authenticating device according to the first embodiment of the present invention.

FIG. 6 is a schematic view of an authenticating device according to a second embodiment of the present invention.

FIG. 7 is a circuit block diagram of the authenticating device according to the second embodiment of the present invention.

FIG. 8 is a schematic view of an authenticating device according to a third embodiment of the present invention.

FIG. 9 is a schematic view of an authenticating device according to a forth embodiment of the present invention.

FIG. 10 is a circuit block diagram of the authenticating device according to the forth embodiment of the present invention.

FIG. 11 is a schematic view of an authenticating device according to a fifth embodiment of the present invention.

### DETAILED DESCRIPTION OF THE INVENTION

A preferred embodiment of the present invention will be described with reference to the drawings.

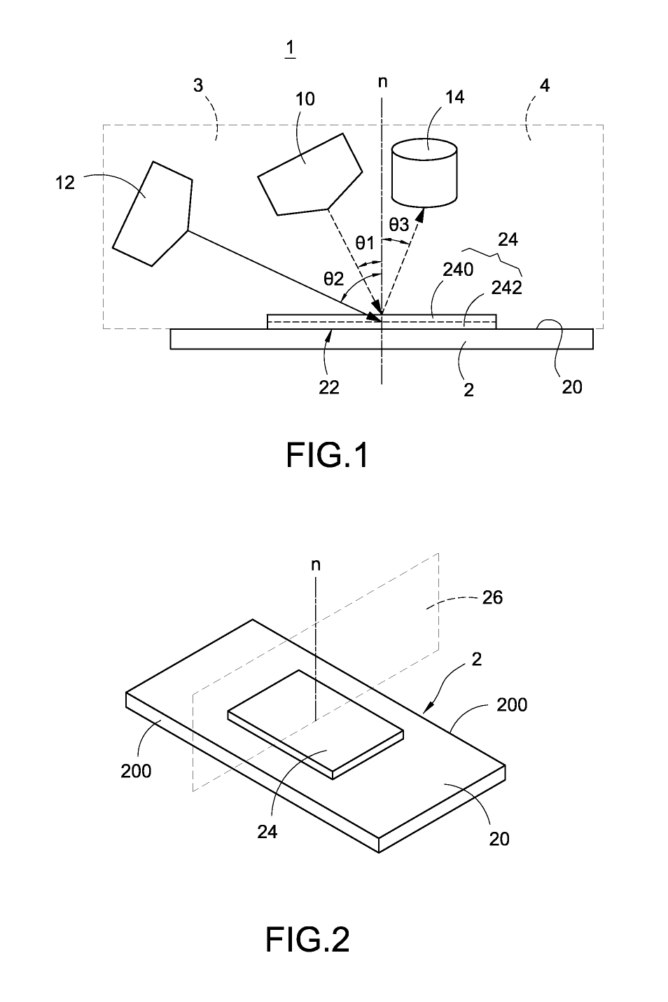

Reference is made to FIG. 1, which is a schematic view of an authenticating device according to a first embodiment of the present invention. The authenticating device 1 is applied to an automatic machine, such as vending machine or automated teller machine (ATM), for authenticating a valuable document 2 (such as paper money or checks). The valuable document 2 includes a first surface 20. A testing area 22 coating with an optically variable ink 24 is formed on the first surface 20. The optically variable ink 24 includes a top ink layer 240 and a bottom ink layer 242, which have two different colors according to different observe angles (namely the top ink layer 240 and the bottom ink layer 242 have different wavelengths while light reflected thereon). In particularly, the bottom ink layer 242 is directly coated on the first surface 20, and the top ink layer 240 is coated on the bottom ink layer 242. The valuable document 2 defines a normal n perpendicular to the first surface 20 and a datum 26 penetrates the normal n and two lateral surfaces 200 of the valuable document 2, as shown in FIG. 2. The datum 26 and the first surface 20 collectively define a first area 3 and a second area 4 adjacent to the first area 3. The authenticating device 1 is used for emitting light with different illuminant angles to the testing area 22 to authenticate the valuable document 2, namely the authenticating device 1 authenticates the valuable document 2 by optical authenticate.

The authenticating device 1 provides lights with two different illuminant angles to light the testing area 22 for authenticating the valuable document 2. The authenticating device 1 includes a first light emitting unit 10, a second light emitting unit 12, and a light receiving component 14.

The first light emitting unit 10 is arranged within a first area 3. The first light emitting unit 10 emits light to the testing area 22 with a first angle θ1 spanning between an optical axis of the first light emitting unit 10 and the normal n. In particularly, the optical axis of the first light emitting unit 10 is a symmetrical axis of optical intensity distribution of light emitted from the first light emitting unit 10. The optical axis of the first light emitting unit 10 is, for example, as the dotted line included the first angle θ1 with the normal n shown in the FIG. 1.

The second light emitting unit 12 is arranged within the first area 3. The second light emitting unit 12 emits light to the testing area 22 with a second angle θ2 spinning between an optical axis of the second light emitting unit 12 and the normal n, the second angle θ2 is larger than the first angle θ1. In particularly, the optical axis of the second light emitting unit 12 is a symmetrical axis of optical intensity distribution of light emitted from the second light emitting unit 12. The optical axis of the second light emitting unit 12 is, for example, as the dotted line included the second angle θ2 with the normal n shown in the FIG. 1. The first angle θ1 is between 0 and 30 degrees, the second angle θ2 is between 40 and 80 degrees, and in this embodiment, the first angle θ1 is 20 degrees, and the second angle θ2 is 60 degrees. As mentioned above, the first light emitting unit 10 is used for providing light with smaller angle (or called direct light) to illuminate the testing area 22, and the second light emitting unit 12 is used for providing light with larger angle (or called inclined light) to illuminate the testing area 22. In this embodiment, the first light emitting unit 10 and the second light emitting unit 12 is used for providing white light.

The light receiving component 14 is arranged within the second area 4, and a third angle θ3 spans between an optical axis of the light receiving component 14 and the normal n for receiving light reflected by the optical variable ink 20. In particular, the optical axis of the light receiving component 14 is a symmetric axis of optical intensity distribution of light received by the light receiving component 14. The optical axis of the light receiving component 14 is, for example, as the dotted line included the third angle θ3 with the normal n shown in the FIG. 1. The third angle θ3 is between 0 and 20 degrees, and in this embodiment, the light receiving unit 14 is a color sensor for sensing a plurality of color lights, and the third angle θ3 is 20 degrees. The light receiving component 14 can be a linear sensor or a surface sensor, the linear sensor is, for example, photodiode (PD), photo transistor (PT), charge-coupled device (CCD) or complementary metal-oxide-semiconductor (CMOS) component, and the surface sensor is, for example, charge-coupled device or complementary metal-oxide-semiconductor component.

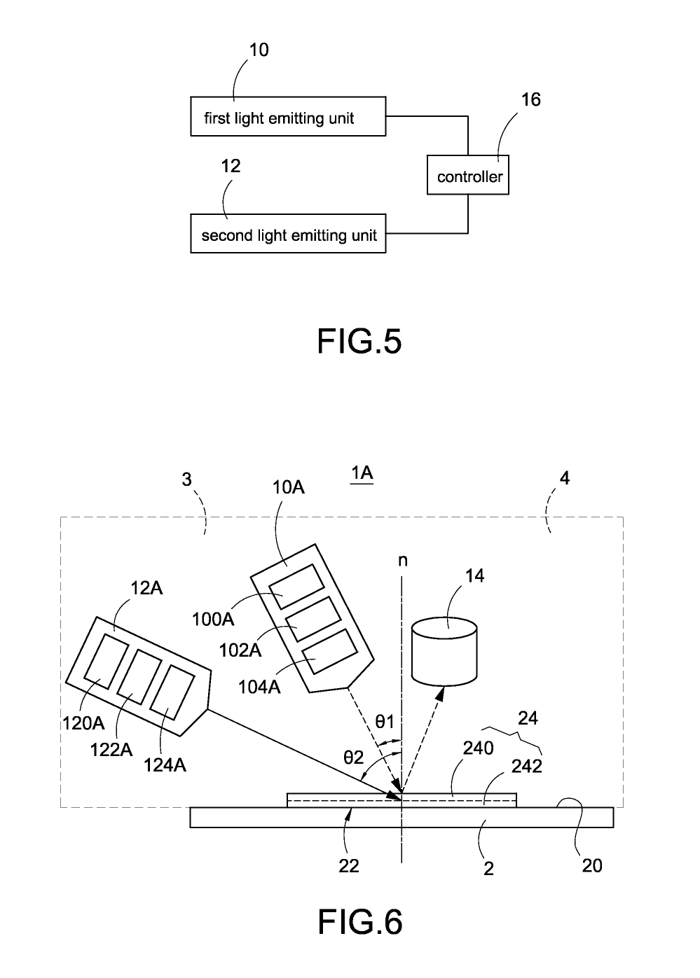

The authenticating device 1 further includes a controller 16, as shown in FIG. 5. The controller 16 is electrically connected to the first light emitting unit 10 and the second light emitting unit 12. The controller 16 is configured to control illuminating times of the first light emitting unit 10 and the second light emitting unit 12 such that only one of the first light emitting unit 10 and the second light emitting unit 12 emits light to illuminate the testing area 22 in a unit time. Namely, the first light emitting unit 10 and the second light emitting unit 12 do not emit light to the testing area 22 in the same time.

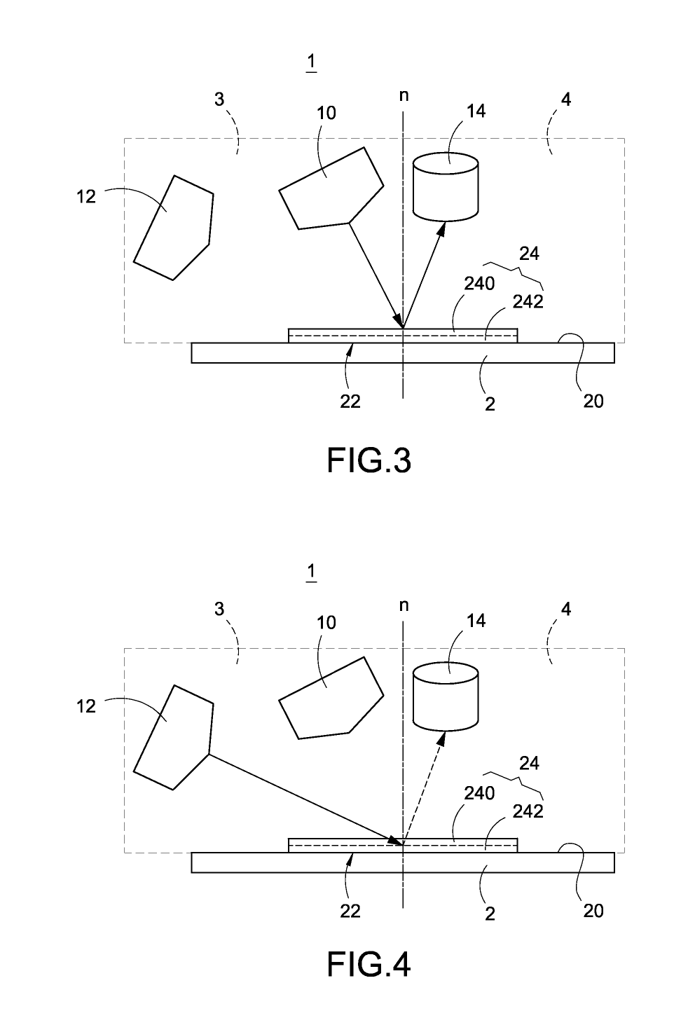

In the practical application, the light with smaller angle emitted from the first light emitting unit 10 and transmitted to the testing area 22 is directly reflected by the top ink layer 240 and then transmitted to the light receiving component 14 (as shown in FIG. 3) while the optical variable ink 24 is exactly coated on the testing area 22. The light with larger angle emitted form the second light emitting unit 12 is refracted by the optical variable ink 24 and entering the bottom ink layer 242. After that, a reflected light is transmitted form the bottom ink layer 242 to the light receiving component 14 (as shown in FIG. 4). The light receiving component 14 receives the lights mentioned above and compares the color difference to authenticate that the optical variable ink 24 is coated on the testing area 22 or not. Besides, wavelength variation of the lights mentioned above is compared to authenticate the valuable document 20.

To sum up, the authenticating device 1 according to this embodiment of the present invention uses the first light emitting unit 10 and second light emitting unit 12 emit direct light and inclined light to illuminate the testing area 22, respectively. The valuable document 2 can be authenticated by comparing wavelengths of lights reflected by the top ink layer 240 and the bottom ink layer 242. Therefore, the authenticating device 1 has advantages of simple frame and low coat.

Reference is made to FIG. 6, which is an authenticating device according to a second embodiment of the present invention. The authenticating device 1A is similar to the authenticating device 1 mentioned in the first embodiment, and the same reference numbers are used in the drawings and the description to refer to the same parts. It should be noted that the first light emitting unit 10A of the authenticating device 1A shown in FIG. 6 includes a red light emitting component 100A, a green light emitting component 102A, and a blue light emitting component 104A. Besides, the second light emitting unit 12A includes a red light emitting component 120A, a green light emitting unit 122A, and a blue light emitting component 124A.

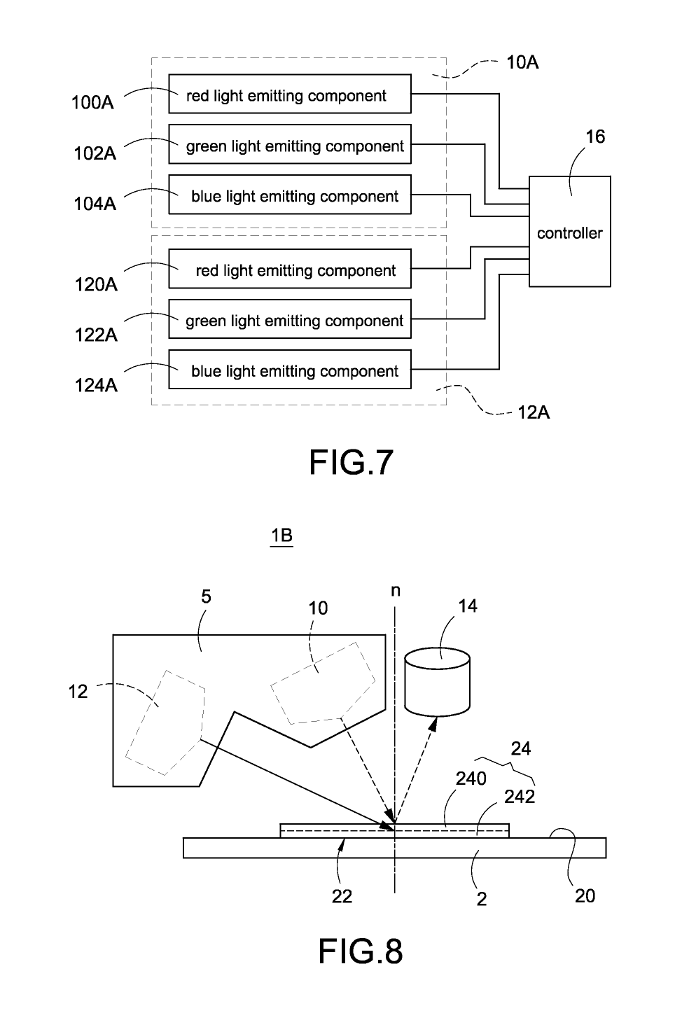

The red light emitting component 100A, the green light emitting component 102A, and the blue light emitting component 104A of the first light emitting unit 10A are electrically connected to the controller 16, respectively (as shown in FIG. 7), and emits light in sequence according to controls of the controller 16. The red light emitting component 100A, the green light emitting component 102A, and the blue light emitting component 104A of the first light emitting unit 10A emit light to the testing area 22 of the valuable document 2 spanning with the first angle θ1. The red light emitting component 120A, the green light emitting component 122A, and the blue light emitting component 124A of the second light emitting unit 12A are electrically connected to the controller 16, respectively, and emits light in sequence according to controls of the controller 16. The red light emitting component 120A, the green light emitting component 122A, and the blue light emitting component 124A of the second light emitting unit 12A emit light to the testing area 22 of the valuable document 2 with the second angle θ2 spinning between the optical axis of the second light emitting unit 12A and the normal n. In this embodiment, the light receiving component 14 is a monochromatic light sensor for sensing light with particular wavelength.

The top ink layer 240 of the optical variable ink 24 directly reflects light with similar wavelength or the same wavelength thereof while the red light emitting component 100A, the green light emitting component 102A, and the blue light emitting component 104A of the first light emitting unit 10A emits light to optical variable ink 24 coated on the testing area 22 with smaller angle in sequence. Therefore a reflected light is generated and transmitted to the light receiving component 14, the light receiving component 14 receives light with similar wavelength or the same wavelength of the top ink layer 240.

Light emitted from the red light emitting component 120A, the green light emitting component 122A, and the blue light emitting component 124A of the second light emitting unit 12A is refracted by the optical variable ink 24 and entering the bottom ink layer 242 while the red light emitting component 120A, the green light emitting component 122A, and the blue light emitting component 124A illuminates the optical variable ink 24 of the testing area 22 with larger angle in sequence. The light entering the bottom ink layer 242 is absorbed by the bottom ink layer 242 and appearing as black color. The light receiving component 14 receives lights with two different colors (the light reflected by the top ink layer 240 and the light reflected by the bottom ink color 242), and the valuable document 20 is authenticated by comparing the colors of the lights mentioned above. The function and relative description of other components of the authenticating device 1A are the same as that of first embodiment mentioned above and are not repeated here for brevity, and the authenticating device 1A can achieve the functions as the authenticating device 1 does.

Reference is made to FIG. 8, which is a schematic view of an authenticating device according to a third embodiment of the present invention. The authenticating device 1B is similar to the authenticating device 1 mentioned in the first embodiment, and the same reference numbers are used in the drawings and the description to refer to the same parts. It should be noted that the authenticating device 1B shown in FIG. 1B further includes an encapsulating body 5.

The first light emitting unit 10 and the second light emitting unit 12 are encapsulated within the encapsulating body 5. Therefore, the first light emitting unit 10 emits light to the testing area 22 with a first angle θ1 spinning between the optical axis of the first light emitting unit 10 and the normal n for providing direct light to authenticate the valuable document 2. The second light emitting unit 12 emits light to the testing unit 22 with the second angle θ2 spanning between the optical axis of the second light emitting unit 12 and the normal n for providing inclined light to authenticate the valuable document 2. The function and relative description of other components of the authenticating device 1B are the same as that of first embodiment mentioned above and are not repeated here for brevity, and the authenticating device 1B can achieve the functions as the authenticating device 1 does.

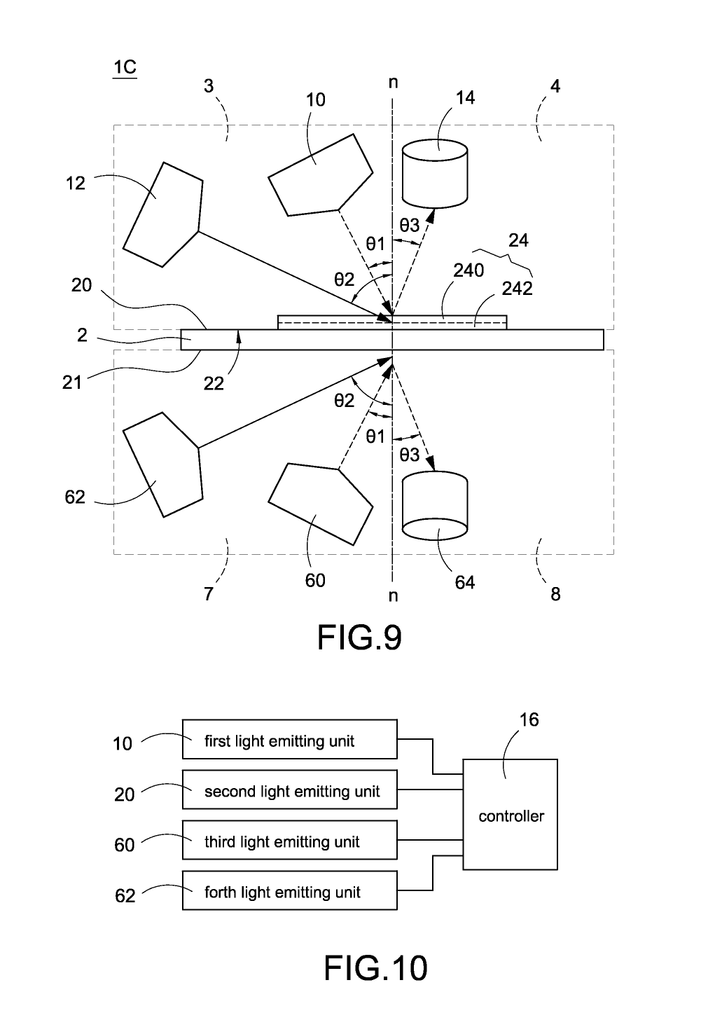

Reference is made to FIG. 9, which is a schematic view of an authenticating device according to a forth embodiment of the present invention. The authenticating device 1C is similar to the authenticating device 1 mentioned in the first embodiment, and the same reference numbers are used in the drawings and the description to refer to the same parts. It should be noted that the authenticating device 1C shown in FIG. 9 further includes a third light emitting unit 60, a forth light emitting unit 62, and a sub-light receiving component 64. The third light emitting unit 60, the forth light emitting unit 62 are electrically connected to the controller 16, respectively, as shown in FIG. 10.

The valuable document 2 further includes a second surface 21 opposite to the first surface 20 and parallel to the first surface 20 so that the normal n perpendicular to the second surface 21. The datum 26 (as shown in FIG. 2) and the second surface 21 collectively define a third area 7 and a forth area 8 adjacent to the third surface 7. The third area 7 corresponds to the first area 3, and the forth area 8 corresponds to the second area 4.

The third light emitting unit 60 is arranged within the third area 7, and emits light to the second surface 21 with the first angle θ1 spanning between an optical axis of the third light emitting unit 60 and the normal 60 for providing direct light to illuminate the second surface 21. The forth light emitting unit 62 is arranged within the third area 7, and emits light to the second surface 21 with the second angle θ2 spanning between an optical axis of the forth light emitting unit 62 and the normal n for providing inclined light to illuminate the second surface 21. The third light emitting unit 60 and the forth light emitting unit 62 are electrically connected to the controller 16, respectively. The controller 16 controls the third light emitting unit 60 and the forth light emitting unit 62 emits light in sequence to the valuable document 2.

The sub-light receiving component 64 is arranged within the forth area 4, and receives light reflected by the second surface 21 with the third angle θ3 spanning between an optical axis of the sub-light receiving component 64 and the normal n. The sub-light receiving component 64 is a linear light sensor or a surface light sensor, the linear sensor is, for example, photodiode, photo transistor, charge-coupled device or complementary metal-oxide-semiconductor component, and the surface sensor is, for example, charge-coupled device or complementary metal-oxide-semiconductor component.

The authenticating device 1C authenticates optical variable ink 24 coated on the first surface 20 and the second surface 21, simultaneously, to increase accuracy of authentication. Besides, when the optical variable ink 24 is just coated on one of the first surface 20 and the second surface 21, user does not turn over the valuable document 2 to make the first surface 20 or the second surface 21 coated with optical variable ink 24 face the authenticating device 1C, and the authenticating device 1C does not need overturning mechanism to turn-over the valuable document 2 such that the manufacturing cost is effectively reduced and increasing usage convenient. The function and relative description of other components of the authenticating device 1C are the same as that of first embodiment mentioned above and are not repeated here for brevity, and the authenticating device 1C can achieve the functions as the authenticating device 1 does.

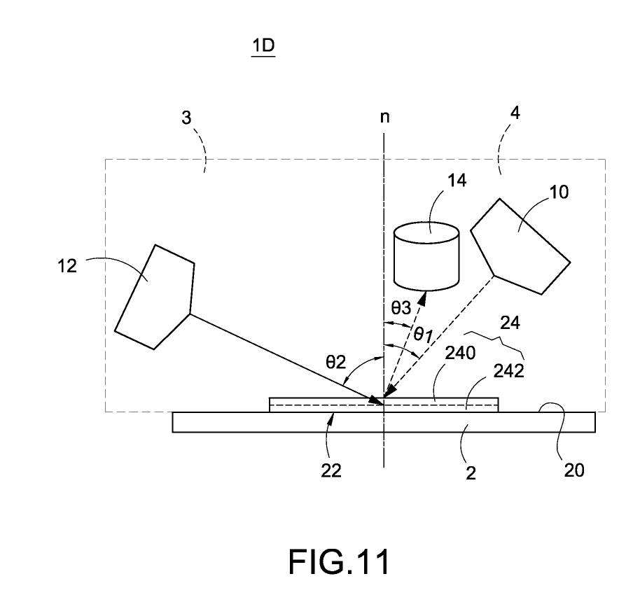

Reference is made to FIG. 11, which is a schematic view of an authenticating device according to a third embodiment of the present invention. The authenticating device 1D is similar to the authenticating device 1 mentioned in the first embodiment, and the same reference numbers are used in the drawings and the description to refer to the same parts. It should be noted that the first light emitting unit 10 of the authenticating device 1D shown in FIG. 11 is arranged within the second area 4, and the first light emitting unit 10 emits light to the testing area 22 with the first angle θ1 spanning between the optical axis of the first light emitting unit 10 and the normal n.

The first angle θ1 is between 0 and 30 degrees for providing first light to authenticate the valuable document 2. The second light emitting unit 12 emits light to the testing area 22 with a second angle θ2 spanning between an optical axis of the second light emitting unit 12 and the normal n for providing inclined light to authenticate the valuable document 2. The second angle θ2 is between 40 and 80 degrees. The first light emitting unit 10 and the second light emitting unit 12 emits light to the testing area 22 in sequence according to controls of the controller 16 for providing light to authenticating the valuable document 2. The function and relative description of other components of the authenticating device 1D are the same as that of first embodiment mentioned above and are not repeated here for brevity, and the authenticating device 1D can achieve the functions as the authenticating device 1 does.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. An authenticating device used for optically authenticating a testing area of a valuable document, the testing area located on a first surface of the valuable document, the valuable document defining a normal perpendicular to the first surface and a datum penetrating the normal and two sides of the valuable document, the datum and the first surface collectively defining a first area and a second area adjacent to the first area, the authenticating device comprising:
a first light emitting unit arranged within the first area, a first angle spanning between an optical axis of the first light emitting unit and the normal;
a second light emitting unit arranged within the first area, a second angle spanning between an optical axis of the second light emitting unit and the normal, the second angle being larger than the first angle;
a light receiving component arranged within the second area, a third angle spanning between an optical axis of the light receiving component and the normal; and
a controller electrically connected to the first light emitting unit and the second light emitting unit, the controller configured to control the first light emitting unit and the second light emitting unit emitting light to the testing area in sequence.

2. The authenticating device in claim 1, wherein the first angle is between 0 and 30 degrees, the second angle is between 40 and 80 degrees, and the third angle is between 0 and 20 degrees.

3. The authenticating device in claim 1, wherein the first light emitting unit and the second light emitting unit generate white light, the light receiving component is color sensor.

4. The authenticating device in claim 1, wherein the first light emitting unit and the second light emitting unit comprises a red light emitting component, a green light emitting component, and a blue light emitting component, respectively, the red light emitting component, the green light emitting component, and the blue light emitting component are electrically connected to the controller, the controller is configured to control the red light emitting component, the green light emitting component, and the blue light emitting component to emit light in sequence, and the light receiving component is a monochromatic light sensor.

5. The authenticating device in claim 1, further comprising a third light emitting unit, a forth light emitting unit, and a sub-light receiving component, the third light emitting unit, the forth light emitting unit, and the sub-light receiving component are arranged ahead a second surface opposite to the first surface of the valuable document, the second surface defining the normal and the datum penetrating the normal and the sides of the valuable document, the second surface and the datum collectively define a third area and a forth area adjacent to the third area, the third light emitting unit and the forth light emitting unit are arranged within the third area, the first angle spans between the third light emitting unit and the normal, the second angle spans between the second light emitting unit and the normal, the sub-light receiving component is arranged within the forth area, and the third angle spans between the sub-light receiving component and the normal.

6. An authenticating device used for optically authenticating a testing area of a valuable document, the testing area located on a first surface of the valuable document, the authenticating device arranged on the first surface with a predetermined height, the valuable document defining a normal perpendicular to the first surface, the authenticating device comprising:
a first light emitting unit, a first angle spanning between an optical axis of the first light emitting unit and the normal;
a second light emitting unit, a second angle spanning between an optical axis of the second light emitting unit and the normal;
a light receiving component, a third angle spanning between an optical axis of light receiving component and the normal; and
a controller electrically connected to the first light emitting unit and the second light emitting unit, the controller configured to control the first light emitting unit and the second light emitting unit emitting light to the testing area in sequence.

7. The authenticating device in claim 6, wherein the first angle is between 1 and 30 degrees, the second angle is between 40 and 80 degrees, and the third angle is between 0 and 20 degrees.

8. The authenticating device in claim 6, wherein the first light emitting unit and the second light emitting unit generate white light, the light receiving component is color sensor.

9. The authenticating device in claim 6, wherein the first light emitting unit and the second light emitting unit comprises a red light emitting component, a green light emitting component, and a blue light emitting component, respectively, the red light emitting component, the green light emitting component, and the blue light emitting component are electrically connected to the controller, the controller controls the red light emitting component, the green light emitting component, and the blue light emitting component emits light to the testing area in sequence, and the light receiving component is a monochromatic light sensor.

10. The authenticating device in claim in claim 6, further comprising a third light emitting unit, a forth light emitting unit, and a sub-light receiving component, the third light emitting unit, the forth light emitting unit, and the sub-light receiving component are arranged on a second surface opposite to the first surface of the valuable document with a predetermined distance, the first angle spans between an optical axis of the third light emitting unit and the normal, the second angle spans between an optical axis of the forth light emitting unit and the normal, and the third angle spans between an optical axis of the sub-light receiving component and the normal.
